(19) United States
(12) Patent Application Publication
(10) Pub. No.: US 2023/0042327 A1
(43) Pub. Date: Feb. 9, 2023

(54) SELF-SUPERVISED LEARNING WITH MODEL AUGMENTATION

(71) Applicant: salesforce.com, inc., San Francisco, CA (US)

(72) Inventors: Zhiwei Liu, Chicago, IL (US); Caiming Xiong, Menlo Park, CA (US); Jia Li, Mountain View, CA (US); Yongjun Chen, Palo Alto, CA (US)

(21) Appl. No.: 17/579,377

(22) Filed: Jan. 19, 2022

Related U.S. Application Data
(60) Provisional application No. 63/230,474, filed on Aug. 6, 2021.
(60) Provisional application No. 63/252,375, filed on Oct. 5, 2021.

(51) Int. Cl. G06N 3/08; G06N 3/04

(52) U.S. Cl. CPC G06N 3/082; G06N 3/04

(57) ABSTRACT

A method for providing a neural network system includes performing contrastive learning to the neural network system to generate a trained neural network system. The performing the contrastive learning includes performing first model augmentation to a first encoder of the neural network system to generate a first embedding of a sample, performing second model augmentation to the first encoder to generate a second embedding of the sample, and optimizing the first encoder using a contrastive loss based on the first embedding and the second embedding. The trained neural network system is provided to perform a task.

### RELATED APPLICATIONS

This application claims priority to U.S. Provisional Patent Application No. 63/230,474 filed Aug. 6, 2021 and U.S. Provisional Patent Application No. 63/252,375 filed Oct. 5, 2021, which are incorporated by reference herein in their entireties.

### TECHNICAL FIELD

The present disclosure relates generally to neural networks and more specifically to machine learning systems and contrastive self-supervised learning (SSL) with model augmentation.

### BACKGROUND

The sequential recommendation in machine learning aims at predicting future items in sequences, where one crucial part is to characterize item relationships in sequences. Traditional sequence modeling in machine learning may be used to verify the superiority of transform, e.g., the self-attention mechanism, in revealing item correlations in sequences. For example, a transformer may be used to infer the sequence embedding at specified positions by weighted aggregation of item embeddings, where the weights are learned via self-attention.

However, the data sparsity issue and noise in sequences undermine the performance of a neural network model (also referred to as model) in sequential recommendation. The former hinders performance due to insufficient training, since the complex structure of a sequential model requires a dense corpus to be adequately trained. The later also impedes the recommendation ability of a model because noisy item sequences are unable to reveal actual item correlations.

Accordingly, it would be advantageous to develop systems and methods for improved sequential recommendation.

### BRIEF DESCRIPTION OF THE DRAWINGS

FIG. 1 is a simplified diagram of a computing device according to some embodiments described herein.

FIG. 2 is a simplified diagram of a method of performing contrastive learning using model augmentation according to some embodiments described herein.

FIG. 3 is a simplified diagram illustrating an example contrastive self-supervised learning system, according to some embodiments described herein.

FIG. 4 is a simplified diagram of a method of performing model augmentation for contrastive learning, according to some embodiments described herein.

FIG. 5A is a simplified diagram of an example neuron masking module for implementing model augmentation using neuron masking, according to some embodiments described herein.

FIG. 5B illustrate another example contrastive learning system with model augmentation using neuron masking, according to some embodiments described herein.

FIG. 6A illustrate an example layer dropping module for implementing model augmentation using layer dropping, according to some embodiments described herein.

FIG. 6B illustrate another example contrastive learning system with model augmentation using layer dropping, according to some embodiments described herein.

FIG. 7 illustrate another example contrastive learning system with model augmentation using neuron masking and layer dropping, according to some embodiments described herein.

FIG. 8 illustrates an example encoder complementing module for implementing model augmentation using encoder complementing, according to some embodiments described herein.

FIG. 9 is a simplified diagram of a computing device that implements the contrastive learning with model augmentation, according to some embodiments described herein.

In the figures, elements having the same designations have the same or similar functions.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

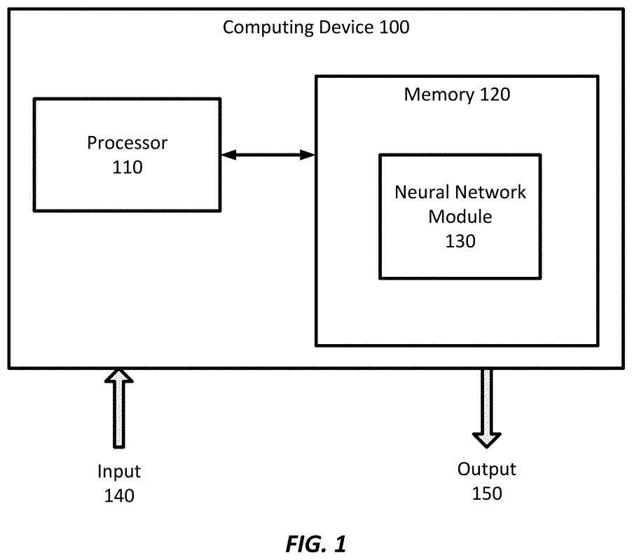

FIG. 1 is a simplified diagram of a computing device 100 according to some embodiments. As shown in FIG. 1, computing device 100 includes a processor 110 coupled to memory 120. Operation of computing device 100 is controlled by processor 110. And although computing device 100 is shown with only one processor 110, it is understood that processor 110 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 100. Computing device 100 may be implemented as a stand-alone subsystem, as a board added to a computing device, and/or as a virtual machine.

Memory 120 may be used to store software executed by computing device 100 and/or one or more data structures used during operation of computing device 100. Memory 120 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 110 and/or memory 120 may be arranged in any suitable physical arrangement. In some embodiments, processor 110 and/or memory 120 may be implemented on a same board, in a same package (e.g., system-in-package), on a same chip (e.g., system-on-chip), and/or the like. In some embodiments, processor 110 and/or memory 120 may include distributed, virtualized, and/or containerized computing resources. Consistent with such embodiments, processor 110 and/or memory 120 may be located in one or more data centers and/or cloud computing facilities.

As shown, memory 120 includes a neural network module 130 that may be used to implement and/or emulate the neural network systems and models described further herein and/or to implement any of the methods described further herein. In some examples, neural network module 130 may be used to translate structured text. In some examples, neural network module 130 may also handle the iterative training and/or evaluation of a translation system or model used to translate the structured text. In some examples, memory 120 may include non-transitory, tangible, machine readable media that includes executable code that when run by one or more processors (e.g., processor 110) may cause the one or more processors to perform the contrastive learning with model augmentation methods described in further detail herein. In some examples, neural network module 130 may be implemented using hardware, software, and/or a combination of hardware and software. As shown, computing device 100 receives input 140, which is provided to neural network module 130, neural network module 130 then generates output 150.

As described above, sequential recommendation aims at predicting the next items in user behaviors, which can be solved by characterizing item relationships in sequences. To address the data sparsity and noise issues in sequences, a self-supervised learning (SSL) paradigm may be used to improve the performance, which employs contrastive learning between positive and negative views of sequences. Various methods may construct views by adopting augmentation from data perspectives, but such data augmentation has various issues. For example, optimal data augmentation methods may be hard to devise. Further, data augmentation methods may destroy sequential correlations. Moreover, such data augmentation may fail to incorporate comprehensive self-supervised signals. To address these issues, systems and methods for contrastive SSL using model augmentation are described below.

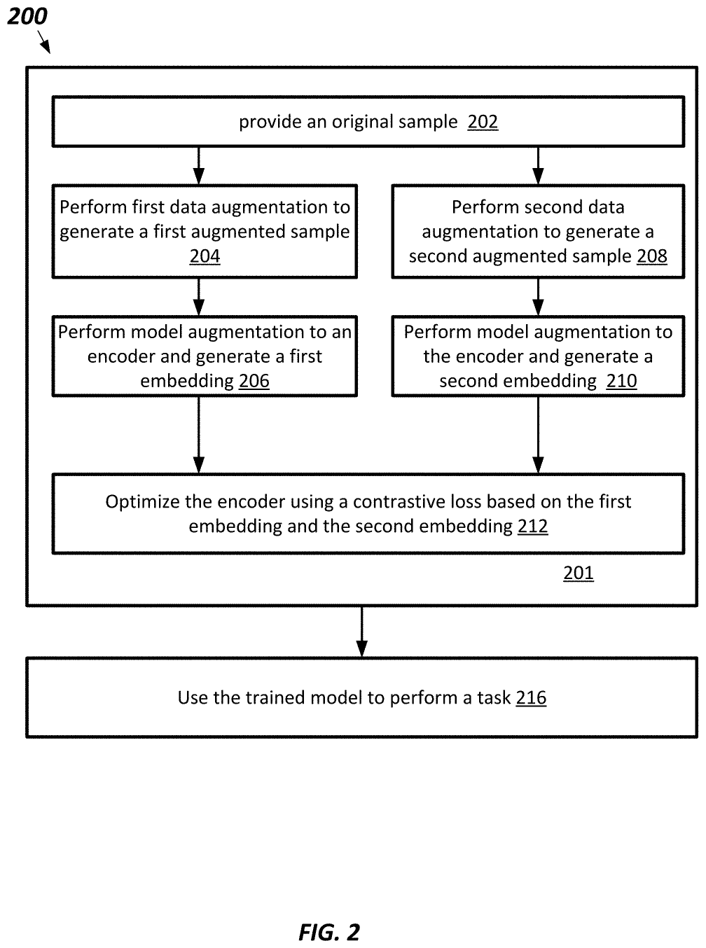

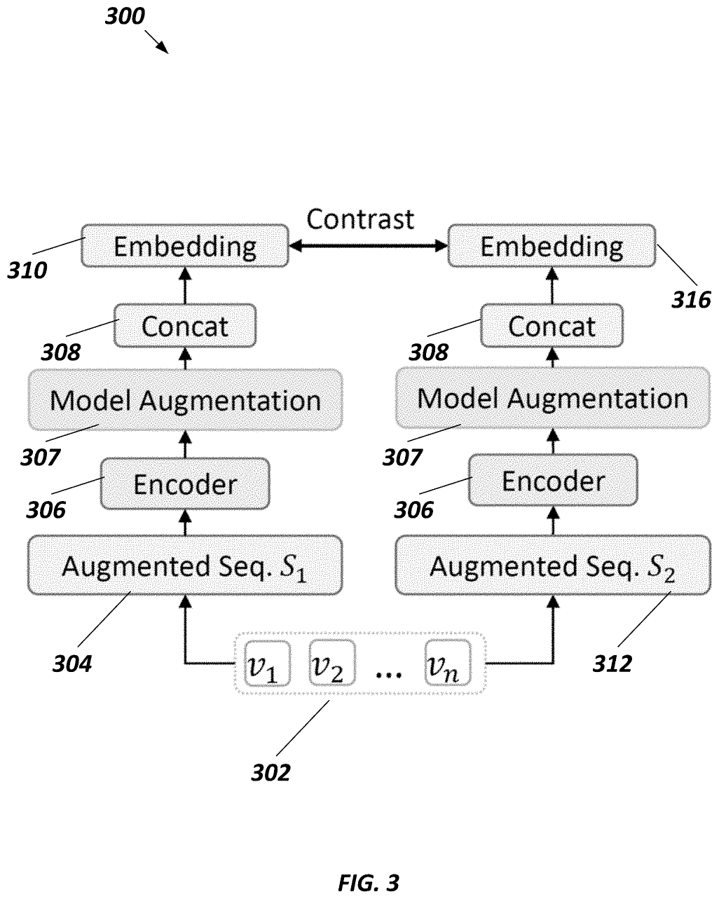

Referring to FIGS. 2 and 3, FIG. 2 is a simplified diagram of method 200 for perform contrastive SSL using model augmentation, and FIG. 3 is an example neural network system 300 for performing the method 200. One or more of the processes of method 200 may be implemented, at least in part, in the form of executable code stored on non-transitory, tangible, machine-readable media that when run by one or more processors may cause the one or more processors to perform one or more of the processes of method 200. In some embodiments, the method 200 may correspond to the method to determine neural network models used by neural network module 130 to perform training and/or perform inference using the neural network model for various tasks. While sequential recommendation tasks are used in the examples described below, method 200 may be used for various tasks including for example sequential recommendation, image recognition, and language modeling.

In various embodiments, method 200 implements model augmentation to construct view pairs for contrastive learning, e.g., as a complement to the data augmentation methods. Moreover, both single-level and multi-level model augmentation methods for constructing view pairs are described. In an example, a multi-level model augmentation method may include multiple levels of various model augmentation methods, including for example, the neuron mask method, the layer drop method, and the encoder complementing method. In another example, a single-level model augmentation method may include a single level of model augmentation, wherein the type of model augmentation may be determined based on a particular task. By using model augmentation, method 200 improves the performance (e.g., for sequential recommendation or other tasks) by constructing views for contrastive SSL with model augmentation.

The method 200 begins at block 201, where contrastive training is performed on a neural network model using one or more batches of training data, and each batch may include one or more original samples. For the description below, an example neural network model for sequential recommendation is used, and the original samples are also referred to as original sequences. For each original sequence in a training batch, blocks 202 through 212 may be performed.

At block 202, an original sequence from the training data is provided. Referring to the example of FIG. 3, an original sequence 302, denoted as sequence su, is received. Here, user and item sets are denoted as U and V respectively. Each user u is associated with a sequence of items in chronological order su=[v₁, . . . , vₜ, . . . , v_{|su|}], where vₜ denotes the item that user u has interacted with at time t and |su| is the total number of items. A sequential recommendation problem may be formulated as follows:

$$\text{?}$$

$$\text{?} \text{indicates text missing or illegible when filed}$$

where v_{|su|+1} denotes the next item in sequence, and in an example, the neural network system for sequential recommendation may select a candidate item that has a highest probability for recommendation.

The method 200 may proceed to block 204, where first data augmentation is performed to the original sequence to generate a first augmented sequence. In some examples, the first data augmentation is optional. Various data augmentation techniques may be used, including for example, crop, mask, reorder, insert, substitute, and/or a combination thereof. Referring to the example of FIG. 3, an augmented sequence 304 is generated by performing first data augmentation to the original sequence 302. The first augmented sequence 304 is provided to an input of an encoder 306.

The method 200 may proceed to block 206, where first model augmentation is performed to the encoder (e.g., encoder 306 of FIG. 3) to augment the encoder and generates first embedding (e.g., embedding 310) of the first augmented sequence (e.g., augmented sequence 304 of FIG. 3). As shown in the example of FIG. 3, model augmentation module 307 performs model augmentation to the encoder to provide an augmented encoder, which generates an output embedding. In some embodiments, concatenation (e.g., by concatenation module 308) may be performed to the output of the augmented encoder to generate embedding 310.

The method 200 may proceed to block 208, where a second data augmentation is performed to the original sequence to generate a second augmented sequence. In some examples, the second data augmentation is optional. In some examples, the second data augmentation is different from the first data augmentation, and the second augmented sequence is different from the first augmented sequence. Referring to the example of FIG. 3, an augmented sequence 312 is generated by performing a second data augmentation to the original sequence 302. The second augmented sequence 312 is provided to an input of the encoder 306.

The method 200 may proceed to block 210, where second model augmentation is performed to the encoder (e.g., encoder 306 of FIG. 3) and generate a second embedding (e.g., embedding 316 of FIG. 3) of the second augmented sequence (e.g., augmented sequence 312 of FIG. 3). As shown in the example of FIG. 3, model augmentation module 307 performs model augmentation to the encoder 306 to provide an augmented encoder, which generates an output embedding. In some embodiments, concatenation (e.g., by concatenation module 308) may be performed to the output of the augmented encoder to generate embedding 316.

The method 200 may proceed to block 212, where an optimization process is performed to the encoder (e.g., encoder 306 of FIG. 3) using a contrastive loss based on the first embedding and the second embedding (e.g., embeddings 310 and 312 of FIG. 3). An example contrastive loss is provided as follows:

$$\text{?}$$

$$\text{?} \text{indicates text missing or illegible when filed}$$

where \tilde{h}₂ᵤ and \tilde{h}₂ᵤ₋₁ denote two views (e.g., two embeddings) constructed for an original sequence sᵤ; [symbol] is an indication function; sim( . , . ) is a similarity function, e.g., a dot-product function. Because each original sequence has 2 views, for a batch with N original sequences, there are 2N samples/views for training. The nominator of the contrastive loss function indicates the agreement maximization between a positive pair, while the denominator is interpreted as push away those negative pairs.

In various embodiments, for sequential recommendation, both the SSL and the next item prediction characterize the item relationships in sequences, which may be combined to generate a final loss L to optimize the encoder. An exemplary final loss is provided as follows:

[symbol]

= [symbol] _{rec}+λ [symbol] ₛₛₗ;

where [symbol] _{rec} is a loss associated with the next item prediction, and [symbol] ₛₛₗ is a contrastive loss as discussed above, where [symbol] ₛₛₗ may be generated using two different views of a same original sequence for contrast, wherein the two different views are generated using data augmentation, model augmentation, and/or a combination thereof.

At block 216, a trained neural network generated by contrastive learning at block 201 may be used to perform a task, e.g., a sequence recommendation task or any other suitable task. For example, the trained neural network may be used to generate a next item prediction for an input sequence.

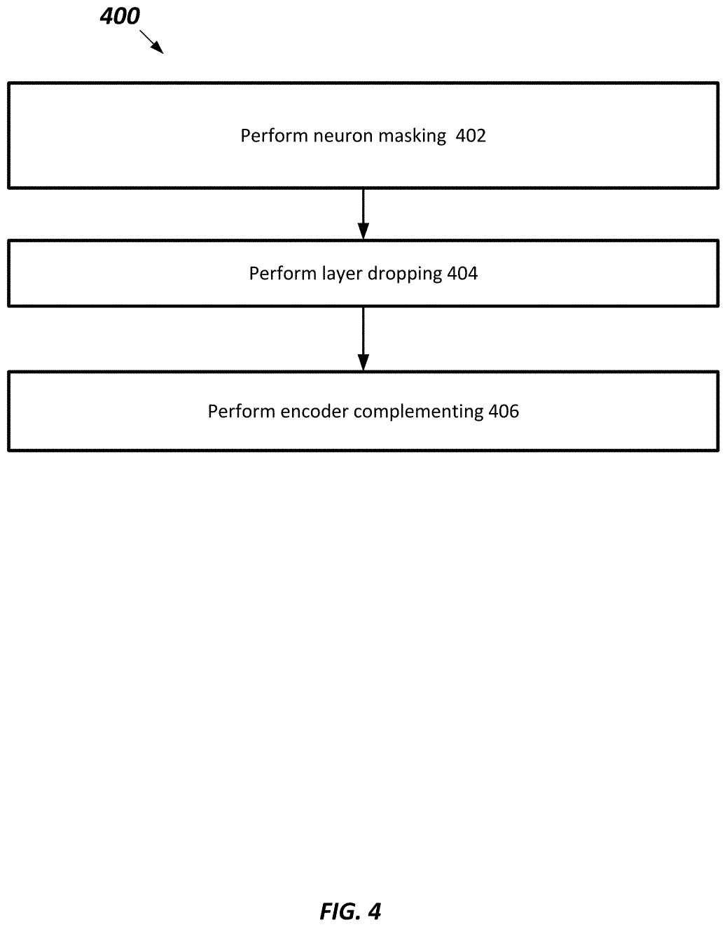

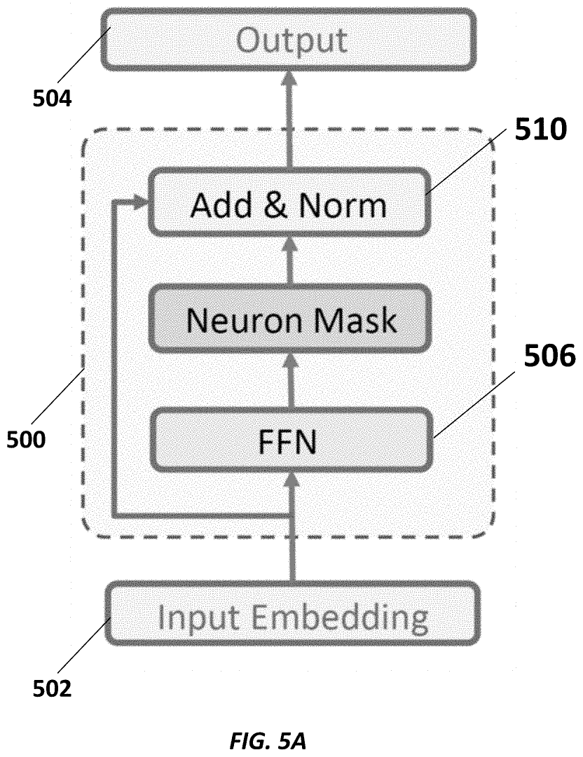

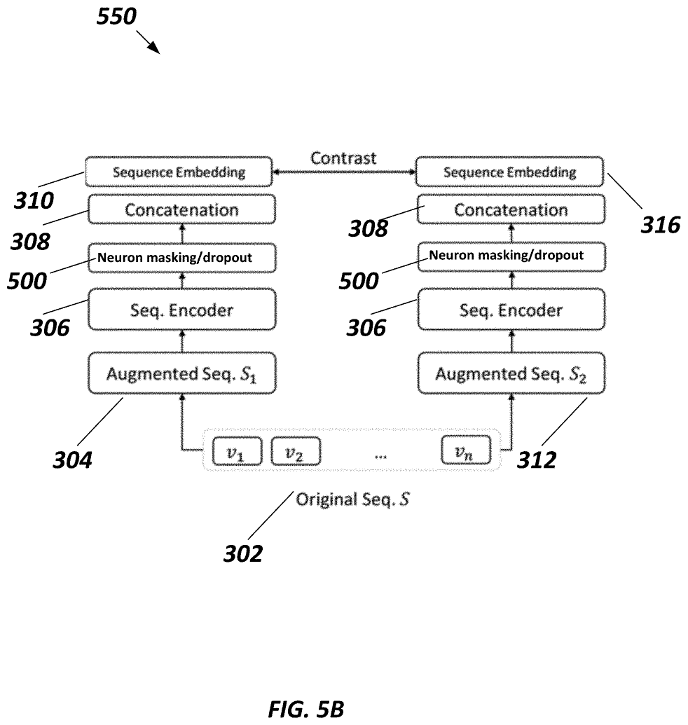

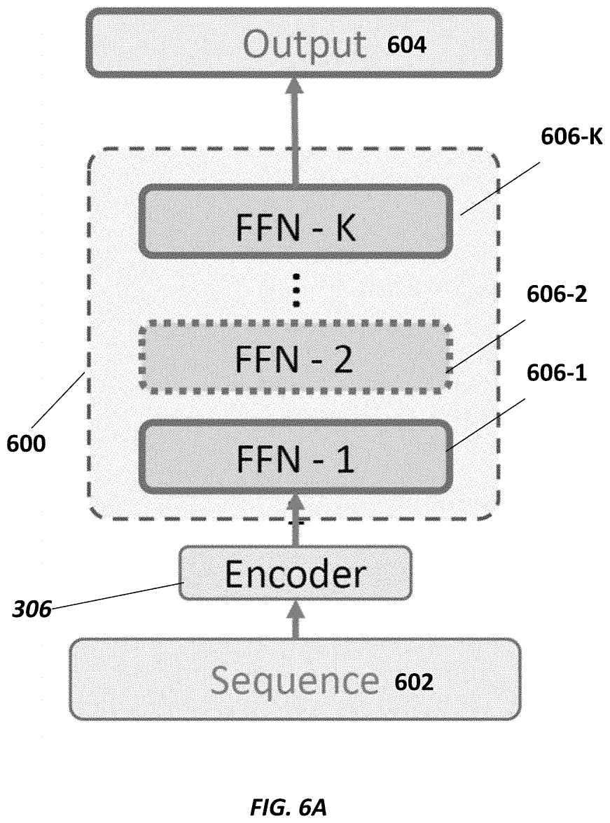

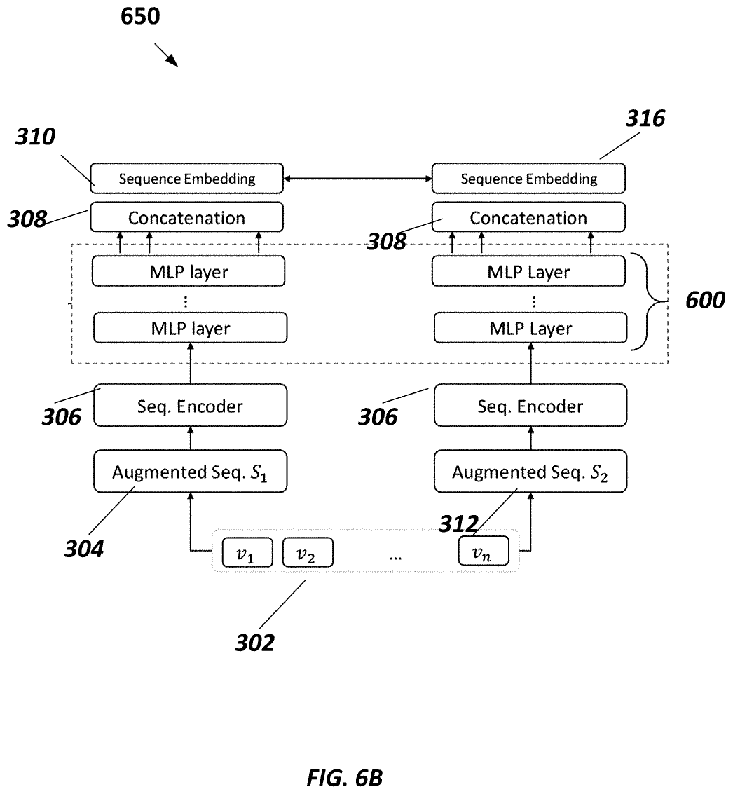

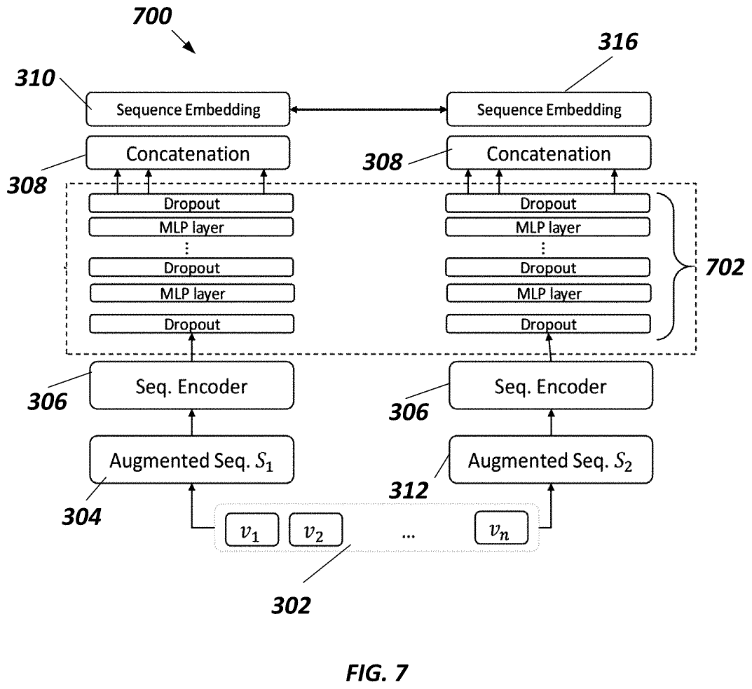

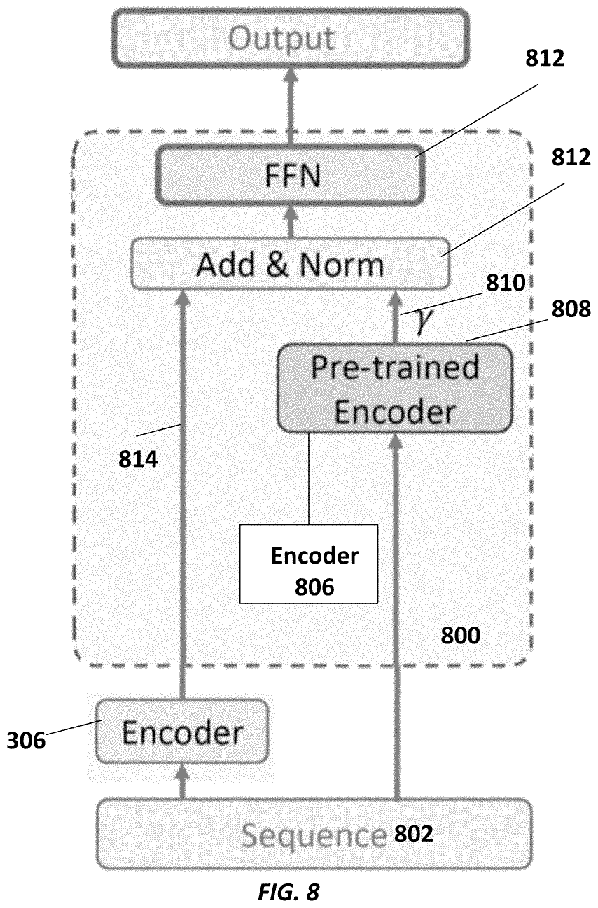

Referring to FIGS. 4, 5A, 5B, 6A, 6B, 7, and 8, example model augmentation methods (e.g., for implementing blocks 206 and 210 of FIG. 2) are described. FIG. 4 illustrates an example model augmentation method 400; FIG. 5A illustrates an example neuron masking module (also referred to as neuron dropout module or dropout module) for implementing model augmentation using neuron masking; FIG. 5B illustrates an example contrastive learning systems including a neuron masking module for model augmentation; FIG. 6A illustrates an example layer dropping module for implementing model augmentation using layer dropping; FIG. 6B illustrates an example contrastive learning systems including a layer dropping module for model augmentation; FIG. 7 illustrates example contrastive learning systems including a model augmentation module with both neuron masking and layer dropping; and FIG. 8 illustrates an example encoder complementing module for implementing model augmentation using encoder complementing.

Referring to FIG. 4, an example model augmentation method 400 that may use one or more levels of different model augmentation methods. The method 400 may proceed to block 402, where neuron masking is performed. Referring to FIG. 5A, an example neuron masking module 500 of an encoder (e.g., encoder 306 of FIG. 3) is illustrated. The neuron masking module 500 may receive hidden embeddings 502 (also referred to as input embeddings), and generate an output embedding 504 to the next layer, through a feed-forward network (FFN) 506. In some embodiments, during training, neuron mask may randomly perform masking of partial neurons in each FFN layer 506, based on a respective masking probability p. A larger value of p leads to more intensive embedding perturbations. As such, by applying different masking probabilities in encoder 306 (e.g., with data augmented sequences 304 and 312 of FIG. 3 or without data augmentation), a pair of different views (e.g., embeddings 310 and 316 of FIG. 3) is generated from one same original sequence from model perspectives. In some embodiments, during each batch of training, the masked neurons are randomly selected, which results in comprehensive contrastive learning on model augmentation. In some embodiments, different probability values may be utilized for different FFN layers of the encoder. In some embodiments, the neuron masking probability is the same for different FFN layers of the encoder. Additionally or alternatively, the neuron mask method 400 may be applied to any neural layer in a model of a neural network system to inject more perturbations.

Referring to FIG. 5B, an example contrastive learning system 550 includes a model augmentation module including neuron masking module 500. The contrastive learning system 550 is substantially similar to the contrastive learning system 300 of FIG. 3 except the differences described below. In the example of FIG. 5B, during training, neuron masking module 500 performs neuron masking twice, by randomly masking partial neurons in one or more layers of the original encoder 306, for generating two different views of the same original sequence 302. Contrastive learning is performed using the two different views.

At block 404, layer dropping is performed. In various embodiments, dropping partial layers of a neural network model (e.g., encoder 306 of FIG. 3) decreases the depth of the neural network model, and reduces complexity. In some embodiments, only shallow embeddings for users and items may be required. In some embodiments, embeddings at shallow layers and deep layers are both important to reflect the comprehensive information of the data. As such, randomly dropping a fraction of layers during training may function as a way of regularization. Model augmentation using layer dropping may enable contrastive learning between embeddings with different depth of layers. In an example, contrastive learning is achieved between shallow embeddings and deep embeddings, thus providing an enhancement, e.g., over models that only contrast between deep features.

In some embodiments, layers in the original encoder are dropped. In some of these embodiments, dropping layers, especially those necessary layers in the original encoder, may destroy original sequential correlations, and views generated by dropping layers may not be a positive pair. Alternatively, in some embodiments, instead of manipulating the original encoder, K FFN layers are stacked after the encoder, and M of them are dropped during each batch of training, where M and K are integers and M<K. In those embodiments, during layer dropping, layers of the original encoder are not dropped.

Referring to FIG. 6A, an example layer dropping module 600 for implementing layer dropping is illustrated. The layer dropping module 600 may receive embeddings 602 (also referred to as embeddings) from the original encoder (e.g., encoder 306 of FIG. 3), and generate an output embedding 604. In various embodiments, the layer dropping module 600 may append K layers 606-1 through 606-K after the encoder 306, and randomly drop M of them (e.g., layer 606-2) during each batch of training, where M may be an integer between 0 through K-1. In some embodiments, the same K and M numbers of appended and dropped FFN layers are applied to encoder 306 for the separate views. In other embodiments, different K and M numbers are applied to encoder 306 for the separate views.

Referring to FIG. 6B, an example contrastive learning system 650 includes a model augmentation module including layer dropping module 600. The layer dropping module 600 may perform model augmentation by appending a number of layers (e.g., multilayer perceptron (MLP) layers, self-attention layers, residual layers, other suitable layers, and/or a combination thereof) to the sequence encoder 306. In the example of FIG. 6B, during training, layer dropping module 600 performs layer dropping twice, by appending and dropping randomly one or more appended layers to the original encoder 306, for generating two different views of the same original sequence 302. Contrastive learning is performed using the two different views.

Referring to FIG. 7, an example contrastive learning system 700 includes a model augmentation module 702 performing both neuron masking and layer dropping. The contrastive learning system 700 is substantially similar to the contrastive learning system 300 of FIG. 3 except the differences described below. The model augmentation module 702 may perform layer dropping by appending a number of layers (e.g., MLP layers or other suitable layers) to the sequence encoder 306, and randomly dropping M layers out of the K total appended layers during training. Furthermore, the model augmentation module 702 may perform neuron masking to randomly mask partial neurons in one or more layers in the original encoder 306 and/or the appended layers.

The method 400 may proceed to block 406, where encoder complementing is performed.

In various embodiments, during self-supervised learning, one single encoder may be employed to generate embeddings of two views of one sequence. While in some embodiments using a single encoder might be effective in revealing complex sequential correlations, contrasting on one single encoder may result in embedding collapse problems for self-supervised learning. Moreover, one single encoder may only be able to reflect the item relationships from a unitary perspective. For example, a Transformer encoder adopts the attentive aggregation of item embeddings to infer sequence embedding, while an RNN structure is more suitable in encoding direct item transitions. Therefore, in some embodiments, distinct encoders may be used to generate views for contrastive learning, which may enable the model to learn comprehensive sequential relationships of items. However, in some embodiments, embeddings from two views of a sequence with distinct encoders may lead to a non-Siamese paradigm for self-supervised learning, which may be hard to train and suffers the embedding collapse problem. Additionally, in examples where two distinct encoders reveal significantly diverse sequential correlations, the embeddings are so far away from each other and become bad views for contrastive learning. Moreover, in some embodiments, two distinct encoders may be optimized during a training phase, but it may still be problematic to combine them for the inference of sequence embeddings to conduct recommendations.

The encoder complementing method described herein may address issues from using a single encoder or using two distinct encoders to generate the views for contrastive learning. In various embodiments, instead of contrastive learning with a single encoder or two distinct encoders, encoder complementing uses a pre-trained encoder to complement model augmentation for the original encoder. Referring to FIG. 8, illustrated is an example encoder complementing module 800 for performing encoder complementing. During pre-training stage, an encoder 806 that is different from encoder 306 is pre-trained with the next-item prediction target to generate a pre-trained encoder 808. Then, during the contrastive self-supervised training stage, this pre-trained encoder 808 is utilized to generate another embedding 810 for a view. A combiner 812 combines the view embedding 814 generated from a model encoder 306 and the view embedding 810 from the pre-trained encoder 808. In some embodiments, this model augmentation is in one branch of the SSL paradigm. The embedding 810 from the pre-trained encoder 808 may be re-scaled by a hyper-parameter y (also referred to as a weight y) before combining with (e.g., adding to) the embedding 814 from the model encoder 306. The smaller value of hyper-parameter y corresponds to injecting fewer perturbations from a distinct encoder 806. The output embedding of the combiner 912 may be passed to the next layer, through a feed-forward network (FFN) 812. By applying different weights y to the output from the pre-trained encoder 808, two different views of the same sequence are provided for contrastive learning.

In some embodiments, parameters of this pre-trained encoder 808 are fixed during the contrastive self-supervised training. In those embodiments, there is no optimization for this pre-trained encoder 808 during the contrastive self-supervised training. Furthermore, during the inference stage, it is no longer required to take account of both encoders 306 and 808, and only model encoder 306 is used.

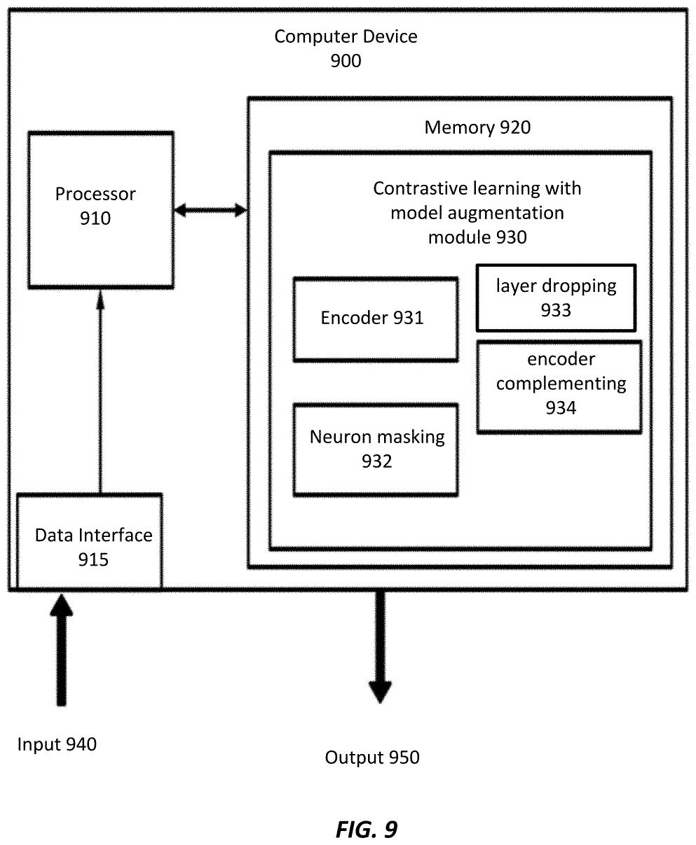

Referring to FIG. 9, illustrated is an example computing device 900 that may be used to implement contrastive learning with model augmentation, according to some embodiments described herein. As shown in FIG. 9, computing device 900 includes a processor 910 coupled to memory 920. Operation of computing device 900 is controlled by processor 910. And although computing device 900 is shown with only one processor 910, it is understood that processor 910 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 900. Computing device 900 may be implemented as a stand-alone subsystem, as a board added to a computing device, and/or as a virtual machine.

Memory 920 may be used to store software executed by computing device 900 and/or one or more data structures used during operation of computing device 900. Memory 920 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 910 and/or memory 920 may be arranged in any suitable physical arrangement. In some embodiments, processor 910 and/or memory 920 may be implemented on a same board, in a same package (e.g., system-in-package), on a same chip (e.g., system-on-chip), and/or the like. In some embodiments, processor 910 and/or memory 920 may include distributed, virtualized, and/or containerized computing resources. Consistent with such embodiments, processor 910 and/or memory 920 may be located in one or more data centers and/or cloud computing facilities.

In some examples, memory 920 may include non-transitory, tangible, machine readable media that includes executable code that when run by one or more processors (e.g., processor 910) may cause the one or more processors to perform the methods described in further detail herein. For example, as shown, memory 920 includes instructions for a neural network module 930 (e.g., neural network module 130 of FIG. 1) that may be used to implement and/or emulate the systems and models, and/or to implement any of the methods described further herein. In some examples, neural network module 930 implements contrastive learning with model augmentation, and may also be referred to as contrastive learning with model augmentation module 930. The contrastive learning with model augmentation module 930 may receive an input 940, e.g., such as original sequences, via a data interface 915. The data interface 915 may be any of a user interface that receives user uploaded input sequences, or a communication interface that may receive or retrieve a previously stored sequences from the database. The contrastive learning with model augmentation module 930 may generate an output 950, such as a prediction of a next item for an input sequence, and/or the like in response to the input 940.

In some embodiments, the contrastive learning with model augmentation module 930 may further includes the encoder module 931 for providing an encoder, the neuron masking module 932 for performing neuron masking, layer dropping module 933 for performing layer dropping, and encoder complementing module 934 for performing encoder complementing.

Some examples of computing devices, such as computing devices 100 and 900 may include non-transitory, tangible, machine readable media that include executable code that when run by one or more processors (e.g., processor 110) may cause the one or more processors to perform the processes of methods 200. Some common forms of machine readable media that may include the processes of methods/systems described herein (e.g., methods/systems of FIGS. 2-8) are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A method for providing a neural network system, comprising:
performing contrastive learning to the neural network system to generate a trained neural network system, wherein the performing the contrastive learning includes:
performing first model augmentation to a first encoder of the neural network system to generate a first embedding of a sample;
performing second model augmentation to the first encoder to generate a second embedding of the sample;
optimizing the first encoder using a contrastive loss based on the first embedding and the second embedding; and
providing the trained neural network system to perform a task.

2. The method of claim 1, wherein the performing the first model augmentation includes:
performing neuron masking by randomly masking one or more neurons associated with the first encoder;
performing layer dropping by dropping one or more layers associated with the first encoder; or
performing encoder complementing using a second encoder.

3. The method of claim 2, wherein the performing the neuron masking includes:
randomly masking the one or more neurons of one or more layers associated with the first encoder based on a masking probability.

4. The method of claim 3, where the same masking probability is applied to each layer.

5. The method of claim 3, wherein different masking probabilities are applied to different layers.

6. The method of claim 2, wherein the performing the layer dropping includes:
appending a plurality of appended layers to the first encoder; and
randomly dropping one or more of the plurality of appended layers.

7. The method of claim 6, wherein the neuron masking is performed to an original layer of the first encoder or one of the plurality of appended layers.

8. The method of claim 2, wherein the performing the encoder complementing includes:
providing a pre-trained encoder by pre-training a second encoder;
providing, by the first encoder, a first intermediate embedding of the sample;
providing, by the pre-trained encoder, a second intermediate embedding of the sample; and
combining the first intermediate embedding and a weighted second intermediate embedding for generating the first embedding for contrastive learning.

9. The method of claim 1, wherein the first encoder and the second encoder have different types.

10. The method of claim 6, wherein the first encoder is a Transformer-based encoder, and the second encoder is a recurrent neural network (RNN) based encoder.

11. A non-transitory machine-readable medium comprising a plurality of machine-readable instructions which, when executed by one or more processors, are adapted to cause the one or more processors to perform a method comprising:
performing contrastive learning to a neural network system to generate a trained neural network system, wherein the performing the contrastive learning includes:
performing first model augmentation to a first encoder of the neural network system to generate a first embedding of a sample;
performing second model augmentation to the first encoder to generate a second embedding of the sample;
optimizing the first encoder using a contrastive loss based on the first embedding and the second embedding; and
providing the trained neural network system to perform a task.

12. The non-transitory machine-readable medium of claim 11, wherein the performing the first model augmentation includes:
performing neuron masking by randomly masking one or more neurons associated with the first encoder;
performing layer dropping by dropping one or more layers associated with the first encoder; or
performing encoder complementing using a second encoder.

13. The non-transitory machine-readable medium of claim 12, wherein the performing the neuron masking includes:
randomly masking the one or more neurons of one or more layers associated with the first encoder based on a masking probability.

14. The non-transitory machine-readable medium of claim 12, wherein the performing the layer dropping includes:
appending a plurality of appended layers to the first encoder; and
randomly dropping one or more of the plurality of appended layers.

15. The non-transitory machine-readable medium of claim 12, wherein the performing the encoder complementing includes:
providing a pre-trained encoder by pre-training a second encoder;
providing, by the first encoder, a first intermediate embedding of the sample;
providing, by the pre-trained encoder, a second intermediate embedding of the sample; and
combining the first intermediate embedding and a weighted second intermediate embedding for generating the first embedding for contrastive learning.

16. A system, comprising:
a non-transitory memory; and
one or more hardware processors coupled to the non-transitory memory and configured to read instructions from the non-transitory memory to cause the system to perform a method comprising:
performing contrastive learning to a neural network system to generate a trained neural network system, wherein the performing the contrastive learning includes:
performing first model augmentation to a first encoder of the neural network system to generate a first embedding of a sample;
performing second model augmentation to the first encoder to generate a second embedding of the sample;
optimizing the first encoder using a contrastive loss based on the first embedding and the second embedding; and
providing the trained neural network system to perform a task.

17. The system of claim 16, wherein the performing the first model augmentation includes:
performing neuron masking by randomly masking one or more neurons associated with the first encoder;
performing layer dropping by dropping one or more layers associated with the first encoder; or
performing encoder complementing using a second encoder.

18. The system of claim 17, wherein the performing the neuron masking includes:
randomly masking the one or more neurons of one or more layers associated with the first encoder based on a masking probability.

19. The system of claim 17, wherein the performing the layer dropping includes:
appending a plurality of appended layers to the first encoder; and
randomly dropping one or more of the plurality of appended layers.

20. The system of claim 17, wherein the performing the encoder complementing includes:
providing a pre-trained encoder by pre-training a second encoder;
providing, by the first encoder, a first intermediate embedding of the sample;
providing, by the pre-trained encoder, a second intermediate embedding of the sample; and
combining the first intermediate embedding and a weighted second intermediate embedding for generating the first embedding for contrastive learning.
